(19) United States
(12) Patent Application Publication
(10) Pub. No.: US 2025/0047447 A1
(43) Pub. Date: Feb. 6, 2025

(54) BLOCK ACKNOWLEDGEMENT FOR AGGREGATED PHYSICAL LAYER PROTOCOL DATA UNIT (A-PPDU) OCCUPYING MULTIPLE SUBCHANNELS

(71) Applicant: NEWRACOM, Inc., Irvine, CA (US)

(72) Inventors: Il-Gu LEE, Seoul (KR); Joonsoo LEE, Seoul (KR); Si-Chan NOH, Seoul (KR); Heejung YU, Daejeon (KR)

(73) Assignee: NEWRACOM, Inc., Irvine, CA (US)

(21) Appl. No.: 18/791,236

(22) Filed: Jul. 31, 2024

Related U.S. Application Data
(60) Provisional application No. 63/517,073, filed on Aug. 1, 2023.

(51) Int. Cl. H04L 5/00; H04L 1/00

(52) U.S. Cl. CPC H04L 5/0055; H04L 1/0058; H04L 5/0046

(57) ABSTRACT

An embodiment is method performed by a first wireless device in a wireless network to implement a block acknowledgement (ACK) scheme for acknowledging data frames received in multiple subchannels. The method includes receiving a plurality of data frames from a second wireless device in a plurality of subchannels, transmitting a block ACK frame to the second wireless device in one of the plurality of subchannels, wherein the block ACK frame includes ACK information for the plurality of subchannels, and wirelessly transmitting one or more data frames to the second wireless device in one or more of the plurality of subchannels, wherein the block ACK frame and the one or more data frames are transmitted simultaneously in different subchannels. The block ACK scheme may improve channel utilization, throughput, and/or latency in the wireless network.

### CROSS-REFERENCE TO RELATED APPLICATION

This application claims the benefit of U.S. Provisional Application No. 63/517,073filed Aug. 1, 2023, which is hereby incorporated by reference.

### TECHNICAL FIELD

The present disclosure generally relates to wireless communications, and more specifically, relates to a block acknowledgement (ACK) scheme for acknowledging data frames received in multiple subchannels.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHz, 6 GHz, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming. The IEEE 802.11be standard is projected to be finalized by the end of 2024, paving the way for the next generation of Wi-Fi devices and networks.

Subchannel selective transmission (SST) is a technique for transmitting data only in selected subchannels. SST may allow for dynamic spectrum utilization within a wide bandwidth. To implement SST, a channel sounding process is needed that allows the SST transmitter (e.g., an AP) to acquire channel quality information of each subchannel (e.g., average channel gain of each subchannel).

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing a format of an aggregated PPDU (A-PPDU) occupying an 80 MHz bandwidth, according to some embodiments.

FIG. 11 is a diagram showing a frame exchange sequence for performing channel sounding for a SST using an A-PPDU and acknowledgement (ACK) feedback, according to some embodiments.

FIG. 12 is a diagram showing a frame exchange sequence for performing channel sounding for a SST using an A-PPDU and ACK and NACK feedback, according to some embodiments.

FIG. 13 is a diagram showing idle subchannels that can be used for other purposes, according to some embodiments.

FIG. 14 is a diagram showing a block ACK acknowledgement scheme for acknowledging data frames received in multiple subchannels, according to some embodiments.

FIG. 15 is a diagram showing a block ACK frame and data frames being transmitted simultaneously, according to some embodiments.

FIG. 16 is a diagram showing a frame exchange sequence using a block ACK scheme, according to some embodiments.

FIG. 17 is a diagram showing a frame exchange sequence using a block ACK scheme where a data frame is transmitted instead of padding bits, according to some embodiments.

FIG. 18 is a flowchart of a method for implementing a block ACK scheme, according to some embodiments.

FIG. 19 is a flowchart of another method for implementing a block ACK scheme, according to some embodiments.

### DETAILED DESCRIPTION

The present disclosure generally relates to wireless communications, and more specifically, relates to a block acknowledgement (ACK) scheme for acknowledging data frames received in multiple subchannels.

An aggregated PPDU (A-PPDU) may be used to realize an efficient channel sounding process for subchannel selective transmission (SST). For example, the channel sounding process may involve a first STA (e.g., an AP) transmitting an A-PPDU to a second STA (e.g., a non-AP STA). The A-PPDU may include multiple sub-PPDUs each occupying a different subchannel. All of the sub-PPDUs may be addressed to the second STA. The second STA may attempt to separately decode each sub-PPDU included in the A-PPDU. The second STA may transmit an ACK frame in each subchannel in which the second STA was able to successfully decode a sub-PPDU of the A-PPDU. Receiving an ACK frame in a particular subchannel can be considered by the first STA as implicit feedback that the particular subchannel has good channel quality. The first STA may select one or more subchannels for use in the SST based on the ACK frames and transmit a data frame in the selected subchannels as part of the SST. For example, the first STA may select the subchannels in which an ACK frame was received from the second STA for use in the SST. The first STA may then transmit a data frame to the second STA in the selected subchannels as part of the SST.

It may be inefficient to transmit an individual ACK frame in each subchannel as feedback of subchannel quality. A block ACK scheme is disclosed herein for more efficiently acknowledging data frames received in multiple subchannels. According to some embodiments, a STA that receives multiple data frame in multiple subchannels (e.g., as part of an A-PPDU) may respond by transmitting a block ACK frame in one of the subchannels, wherein the block ACK frame includes ACK information for multiple subchannels. Transmitting a block ACK frame that includes ACK information for multiple subchannels avoids the need to transmit individual ACK and/or no ACK (NACK) frames in each subchannel, which may free up some subchannels so that they can be used for other purposes. For example, the STA may transmit one or more data frames (e.g., that include low latency data) simultaneously with the block ACK frame in one or more unused subchannels to improve channel utilization and latency. The block ACK scheme disclosed herein may be suitable for being used in next generation wireless networking standards (e.g., future IEEE 802.11 wireless networking standards) that aim to improve latency, throughput, and energy efficiency.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

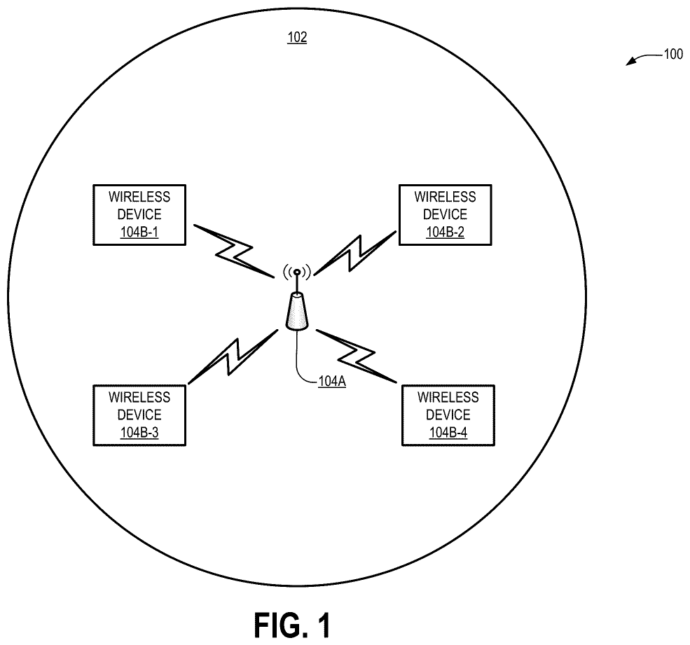

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B1-104B4 that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B1-104B4) may be collectively referred to as STAs. However, for ease of description, only the non-AP STAs may be referred to as STAs unless the context indicates otherwise. Although shown with four non-AP STAs (e.g., the wireless devices 104B1-104B4), the WLAN 100 may include any number of non-AP STAs (e.g., one or more wireless devices 104B).

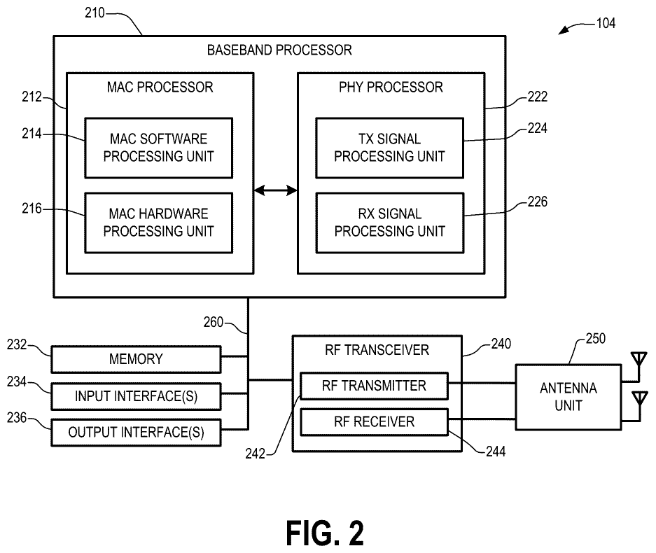

FIG. 2 illustrates a schematic block diagram of a wireless device 104, according to an embodiment. The wireless device 104 may be the wireless device 104A (i.e., the AP of the WLAN 100) or any of the wireless devices 104B1-104B4 in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

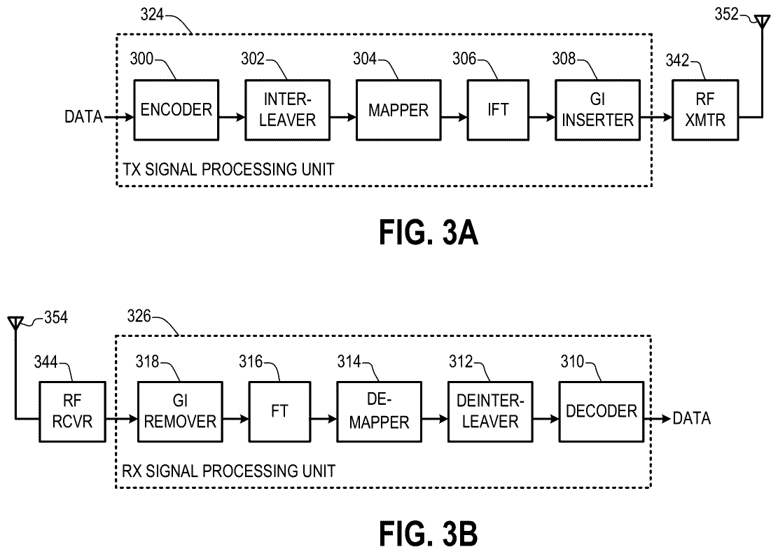

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MH2, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

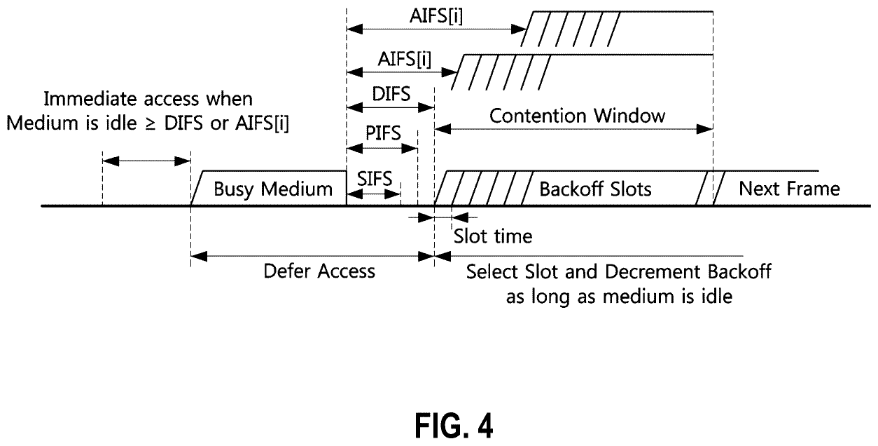

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS [i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QOS) functionality (that is, a QOS STA) may transmit the frame after performing backoff if an AIFS for an associated access category (AC) (i.e., AIFS [AC]) has elapsed. When transmitted by the QOS STA, any of the data frame, the management frame, and the control frame, which is not the response frame, may use the AIFS [AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

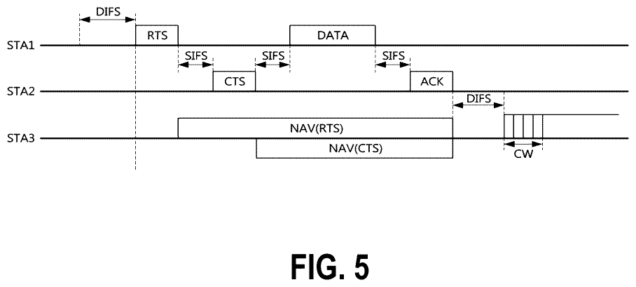

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

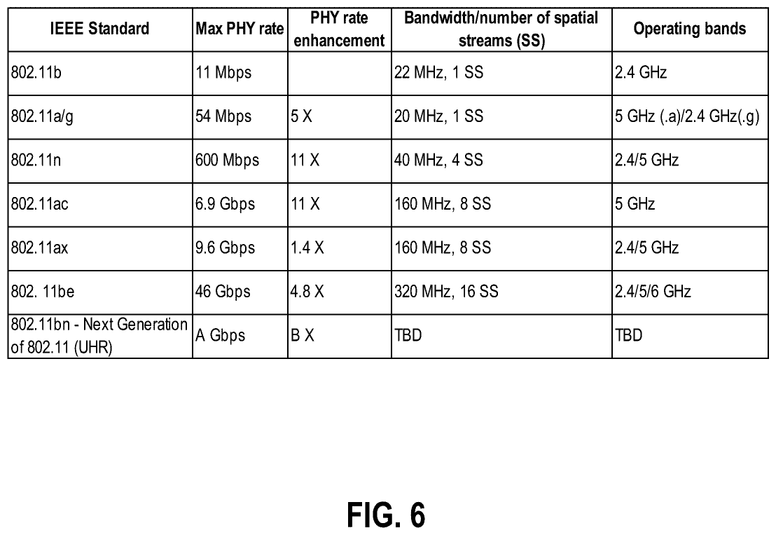

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHz) for IEEE 802.11be, more than 1 GHz of additional unlicensed spectrum is likely to be available because the 6 GHz band (5.925-7.125 GHz) is being considered for unlicensed use. This would allow APs and STAs to become tri-band devices. Larger than 160 MHz data transmissions (e.g., 320 MHz or 640 MHz) could be considered to increase the maximum PHY rate. For example, 320 MHz or 160+160 MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

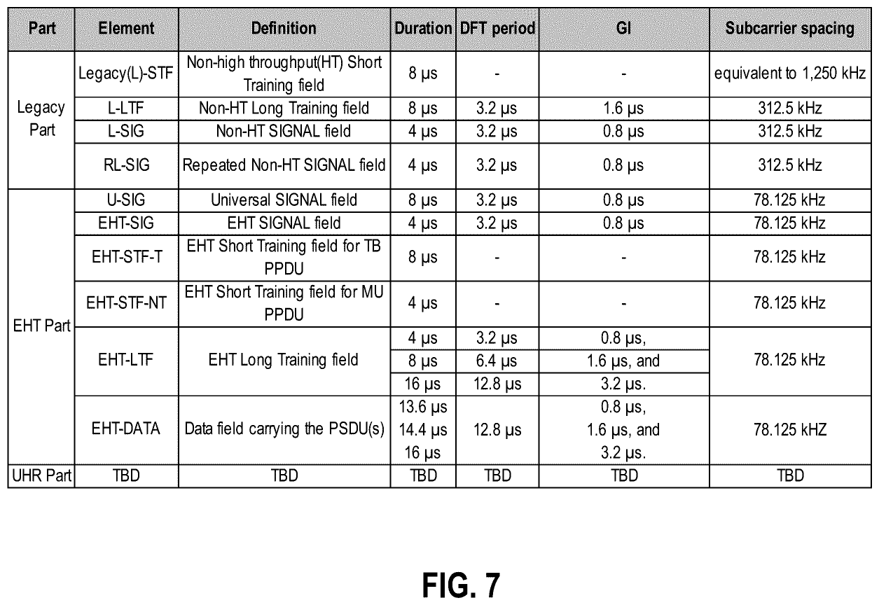

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

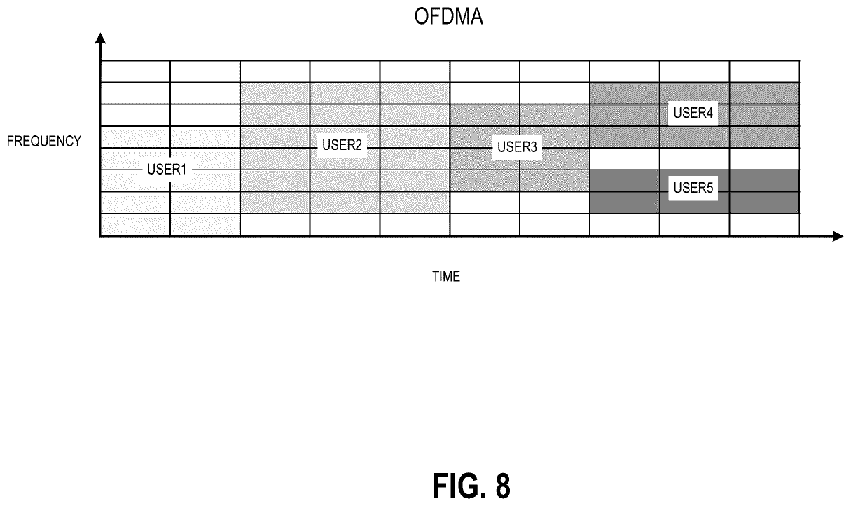

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

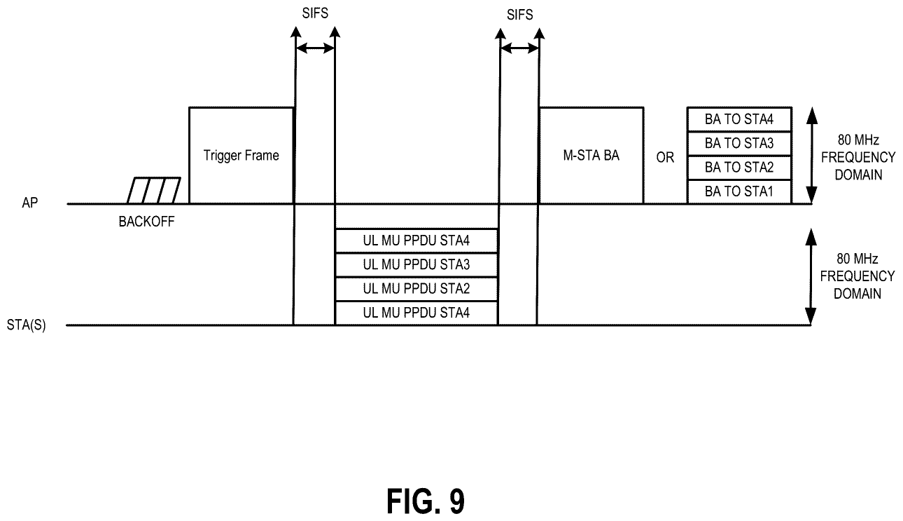

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

The frequency selectivity of a channel frequency response can be exploited for efficient spectrum utilization in wide bandwidth transmissions. For example, data can be transmitted more reliably by transmitting the data in subchannels with higher channel gain. SST is a technique for transmitting data only in selected subchannels. For SST, the SST transmitter (e.g., an AP) should obtain information regarding the channel quality of each subchannel through a channel sounding process. A channel sounding process using a null data packet announcement (NDPA) frame and a null data packet (NDP) frame for beamformed transmissions was introduced in previous IEEE 802.11 wireless networking standards (e.g., in IEEE 802.11n/ac/ax/be). Such NDP-based channel sounding process incurs unnecessary overhead for SST because SST does not require obtaining the magnitude and phase of each subcarrier, but just requires obtaining the channel quality of each subchannel (e.g., the average channel gain of the subcarriers in each subchannel). Another conventional channel sounding process involves the transmitter sequentially transmitting data frames or control frames to the receiver in each subchannel to allow the receiver to measure the channel quality of each subchannel. The receiver may then transmit channel quality information of each subchannel to the transmitter. However, such sequential channel sounding process may take a relatively long time to obtain the channel quality information of all subchannels. When using a wideband PPDU (e.g., a PPDU occupying the entire bandwidth), it is difficult to assess the channel quality of each subchannel with ACK frame feedback. The ACK frame feedback just indicates that the overall channel quality is good enough for the receiver to correctly decode a data frame. However, the channel qualities of individual subchannels cannot be accurately assessed with such ACK frame feedback. As will be described in additional detail herein, an A-PPDU format can be used to realize a more efficient channel sounding process for obtaining channel quality information of multiple subchannels.

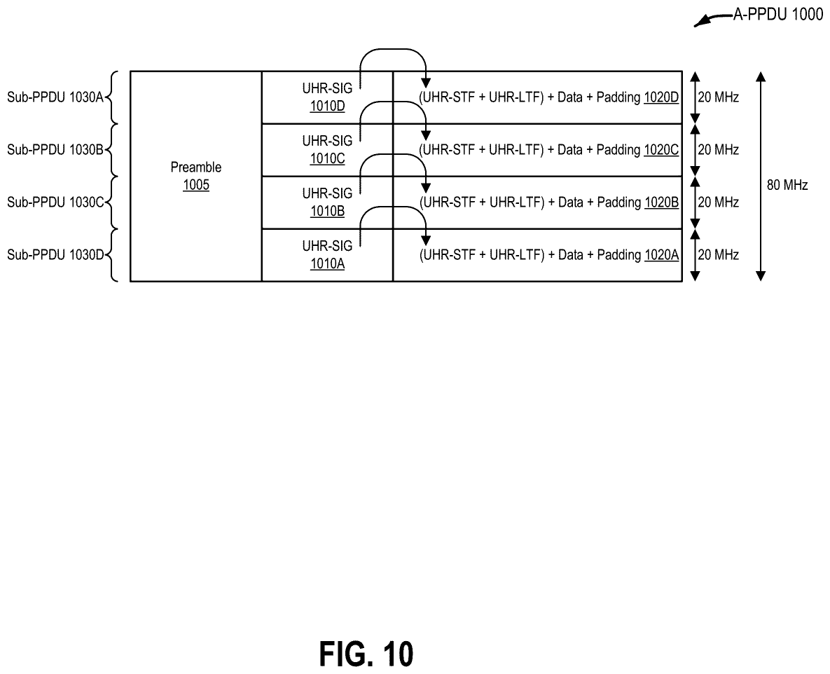

FIG. 10 is a diagram showing a format of an A-PPDU occupying an 80 MHz bandwidth, according to some embodiments.

As shown in the diagram, the A-PPDU 1000 may occupy an 80 MHz bandwidth. The 80 MHz bandwidth may be divided into four 20 MHz subchannels. The A-PPDU 1000 may include a preamble 1005, UHR-SIG fields 1010A-D, and data and padding fields 1020A-D. The preamble 1005 may be common across the entire 80 MHz bandwidth. The preamble 1005 may be a legacy preamble or similar preamble (e.g., such that it is compatible with legacy IEEE 802.11 wireless networking standards such as IEEE 802.11ax and IEEE 802.11be) and may include fields such as a legacy signal (L-SIG) field. In an embodiment, each 20 MHz subchannel has a separate preamble. As shown in the diagram, UHR-SIG 1010A and data and padding field 1020A may occupy the first 20 MHz subchannel, UHR-SIG 1010B and data and padding field 1020B may occupy the second 20 MHz subchannel, UHR-SIG 1010C and data and padding field 1020C may occupy the third 20 MHz subchannel, and UHR-SIG 1010D and data and padding field 1020D may occupy the fourth 20 MHz subchannel. Each data and padding field 1020 may include data and padding. Each UHR-SIG field 1010 may include information regarding the data and padding included in the corresponding data and padding field 1020 occupying the same subchannel. In an embodiment, one or more of the data and padding fields 1020 include the same data and padding to allow the receiver to more reliably recover/decode the data and padding (and thus reduce the number of retransmissions). In an embodiment, all of the data padding fields 1020 include different data and padding. The contents of the A-PPDU 1000 occupying each 20 MHz subchannel may be considered to be a separate sub-PPDU 830. Thus, the A-PPDU 1000 shown in the diagram may be considered as including sub-PPDU 1030A, sub-PPDU 1030B, sub-PPDU 1030C, and sub-PPDU 1030D, with each sub-PPDU 1030 occupying a different 20 MHz subchannel. In an embodiment, each sub-PPDU 1030 further includes a UHR short training field and a UHR long training field (UHR-STF+UHR-LTF) between the UHR-SIG field 1010 and the data and padding field 1020. It should be appreciated that a sub-PPDU 1030 can include other fields than what is shown in the diagram.

In an embodiment, all of the sub-PPDUs 1030 included in the A-PPDU 1000 may be addressed to the same STA. In an embodiment, at least two of the sub-PPDUs 1030 included in the A-PPDU 1000 may be addressed to the same STA. Transmitting the A-PPDU 1000 with multiple sub-PPDUs 1030 addressed to the same STA may be less efficient in terms of data rate compared to transmitting a single wideband PPDU to the STA (e.g., due to the unused subcarriers in the boundaries between subchannels), but as will be described herein in additional detail, such A-PPDU 1000 may be used to realize an efficient channel sounding process for SST. In an embodiment, different sub-PPDUs 1030 included in the A-PPDU 1000 may be addressed to different STAs. In an embodiment, as shown in the diagram, all of the sub-PPDUs 1030 included in the A-PPDU 1000 have the same PPDU format (e.g., all sub-PPDUs 1030 have an ultra high reliability (UHR) PPDU format). In an embodiment, at least two of the sub-PPDUs 1030 included in the A-PPDU 1000 have different PPDU formats (e.g., one sub-PPDU 1030 may have a UHR PPDU format, another sub-PPDU 1030 included in the same A-PPDU 1000 may have a high efficiency (HE) PPDU format, and yet another sub-PPDU 1030 included in the same A-PPDU 1000 may have an extremely high throughput (EHT) PPDU format). In an embodiment, each sub-PPDU 1030 included in the A-PPDU 1000 occupies a bandwidth that is a multiple of 20 MHz (e.g., 20 MHz, 40 MHz, 80 MHz, or 160 MHz).

A STA that receives the A-PPDU 1000 or an A-PPDU having a similar format may be able to separately decode each sub-PPDU 1030 included in the A-PPDU 1000. That is, a STA may be able to separately decode different sub-PPDUs 1030 of the A-PPDU 1000 occupying different 20 MHz subchannels. This is because each 20 MHz sub-PPDU 1030 has its own UHR-SIG field 1010 that allows the receiving STA to obtain information needed to decode the data/payload included in the sub-PPDU 1030 such as information regarding the modulation coding scheme (MCS), the bandwidth, the resource unit (RU) allocation, etc. While the A-PPDU 1000 is shown in the diagram as occupying an 80 MHz bandwidth and each of the sub-PPDUs 1030 included in the A-PPDU 1000 are shown in the diagram as occupying a 20 MHz subchannel bandwidth, it should be appreciated that the A-PPDU 1000 can occupy a different bandwidth size (e.g., 160 MHz or 320 MHz) and/or the sub-PPDUs 1030 can occupy a different subchannel bandwidth size (e.g., 40 MHz, 80 MHz, 160 MHz). Also, it should be appreciated that different sub-PPDUs 1030 within the same A-PPDU 1000 can occupy different subchannel bandwidth sizes. Thus, the A-PPDU format shown in the diagram should be regarded as illustrative rather than limiting. As will be described in additional detail herein, the A-PPDU 1000 or an A-PPDU having a similar format may be used for realizing an efficient channel sounding process.

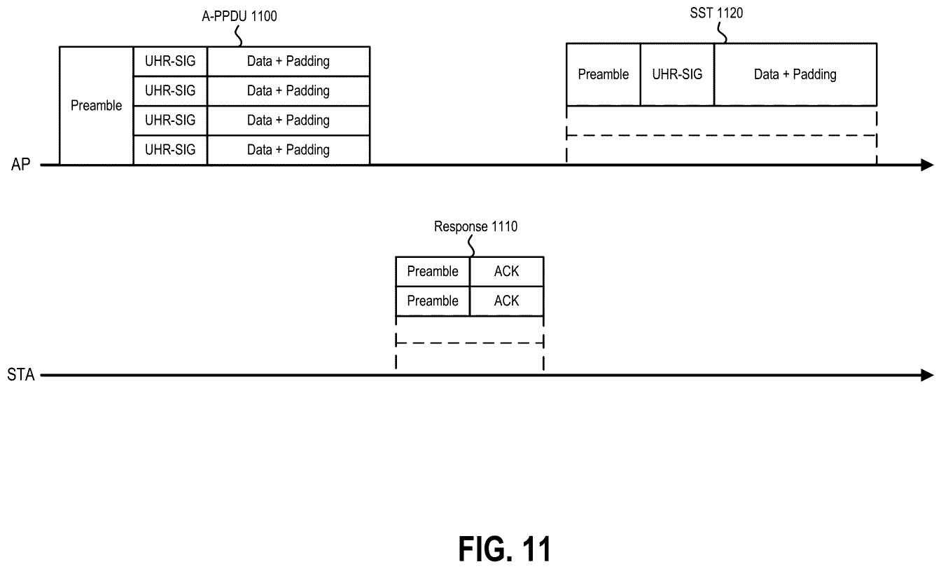

FIG. 11 is a diagram showing a frame exchange sequence for performing channel sounding for a SST using an A-PPDU and ACK feedback, according to some embodiments.

As shown in the diagram, an AP may transmit an A-PPDU 1100 to a STA. The A-PPDU 1100 may have the A-PPDU format shown in FIG. 10 or a similar format. The A-PPDU 1100 may occupy an 80 MHz channel/bandwidth. The A-PPDU 1100 may include four sub-PPDUs each occupying a different 20 MHz subchannel within the 80 MHz channel/bandwidth.

The STA may attempt to separately decode each sub-PPDU included in the A-PPDU 1100. The STA may then transmit an ACK frame to the AP in each subchannel in which the sub-PPDU of the A-PPDU 1100 was successfully decoded (without error) in its response 1110 to the A-PPDU 1100. In the example shown in the diagram, it is assumed that the STA was able to successfully decode the sub-PPDUs of the A-PPDU 1100 occupying the third and fourth 20 MHz subchannels (the upper two 20 MHz subchannels shown in the diagram), but was not able to successfully decode the sub-PPDUs occupying the first and second 20 MHz subchannels (the lower two 20 MHz subchannels shown in the diagram). Thus, the STA may transmit separate ACK frames to the AP in the third and fourth 20 MHz subchannels in its response 1110 to the A-PPDU 1100.

In an embodiment, the STA transmits the ACK frames to the AP as part of an A-PPDU. Such A-PPDU may referred to as a response A-PPDU because it is transmitted in response to the A-PPDU 1100 transmitted by the AP. In an embodiment, the response A-PPDU and the original A-PPDU 1100 use the same subchannel partitioning (e.g., 80 MHz bandwidth divided into four 20 MHz subchannels).

The AP may use the presence of ACK frames or the lack thereof as implicit feedback of the channel quality of the subchannels. In the example shown in the diagram, the AP receives ACK frames from the STA in the third and fourth 20 MHz subchannels. Thus, the AP may consider the third and fourth 20 MHz subchannels as having good channel quality. Also, in this example, the AP does not receive an ACK frame from the STA in the first and second 20 MHz subchannels. Thus, the AP may consider the first and second 20 MHz subchannels as having poor channel quality.

The AP may select one or more 20 MHz subchannels for use in a SST 920 based on the ACK frames it received from the STA. For example, the AP may select the 20 MHz subchannels in which it received an ACK frame from the STA for use in the SST 920. In this example, since the AP received ACK frames from the STA in the third and fourth 20 MHz subchannels (which indicates that those 20 MHz subchannels have good channel quality), the AP may select those subchannels for use in the SST 920. However, the AP may exclude the first and second 20 MHz subchannels from being used in the SST 920 because the AP did not receive an ACK frame from the STA in those 20 MHz subchannels (which indicates that those 20 MHz subchannels have poor channel quality). The AP may then transmit a data frame to the STA in the selected 20 MHz subchannels as part of the SST 1120. In the example shown in the diagram, the AP transmits a data frame in the third and fourth 20 MHz subchannels (the upper 40 MHz subchannel) as part of the SST 1120. In an embodiment, the AP may transmit a separate data frame in each selected subchannel (e.g., transmit one data frame in the third 20 MHz subchannel and transmit a different data frame in the fourth 20 MHz subchannel) as part of the SST 1120 instead of transmitting a single data frame that occupies the selected subchannels as shown in the diagram.

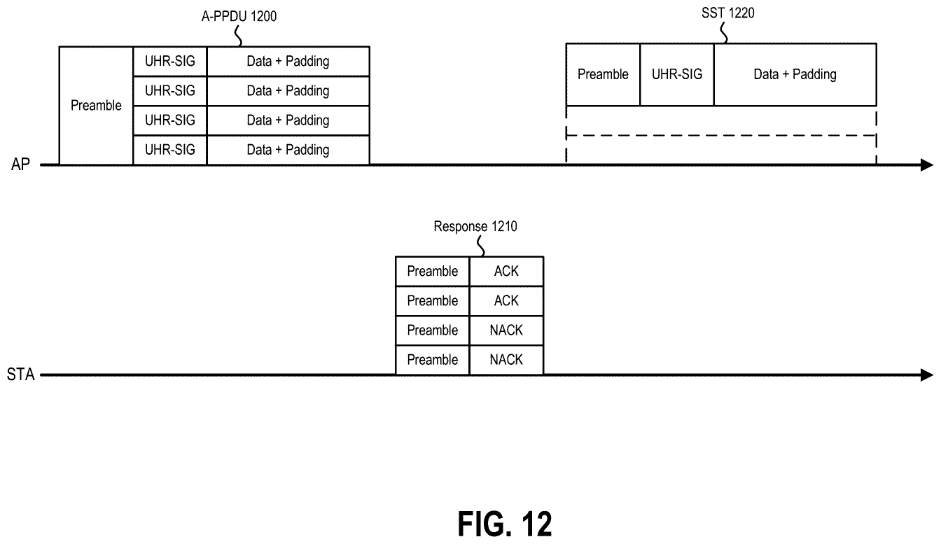

FIG. 12 is a diagram showing a frame exchange sequence for performing channel sounding for a SST using an A-PPDU and ACK and NACK feedback, according to some embodiments.

In an embodiment, in addition to transmitting an ACK frame in each 20 MHz subchannel in which the STA was able to successfully decode a sub-PPDU of an A-PPDU, the STA may transmit a negative acknowledgement (NACK) frame in each 20 MHz subchannel in which the STA was not able to successfully decode a sub-PPDU of the A-PPDU (e.g., not able to successfully decode the data and padding included in the sub-PPDU). For example, after the AP transmits an A-PPDU 1200 to the STA, the STA may attempt to separately decode each sub-PPDU included in the A-PPDU. In the example shown in the diagram, it is assumed again that the STA was able to successfully decode the sub-PPDUs of the A-PPDU 1200 included in the third and fourth 20 MHz subchannels, but that the STA was not able to successfully decode the sub-PPDUs included in the first and second 20 MHz subchannels. Thus, the STA may transmit separate ACK frames to the AP in the third and fourth 20 MHz subchannels and transmit separate NACK frames to the AP in the first and second 20 MHz subchannels in its response 1210 to the A-PPDU 1200. Transmitting the NACK frame(s) may allow the AP to more accurately assess the channel quality of subchannels by allowing the AP to obtain some feedback regarding subchannels having poor channel quality (instead of only obtaining feedback regarding subchannels having good channel quality). The AP may then select one or more subchannels for use in an SST 1220 and transmit data frame(s) in the selected subchannels as part of the SST 1220, as described above. For example, in the example shown in the diagram, the AP transmits a data frame in the third and fourth 20 MHz subchannels (the upper 40 MHz subchannel) as part of the SST 1220 because ACK frames were received in those 20 MHz subchannels. The first and second 20 MHz subchannels are unoccupied in the SST 1220 because the AP received NACK frames in those 20 MHz subchannels.

In an embodiment, the STA transmits the ACK frames and NACK frames to the AP as part of a response A-PPDU. In an embodiment, the response A-PPDU and the original A-PPDU 1200 use the same subchannel partitioning.

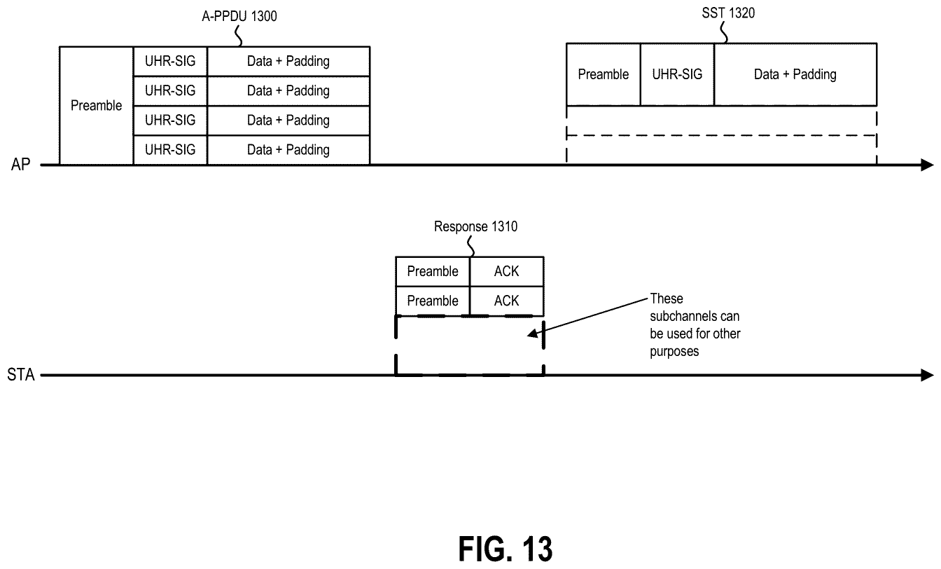

FIG. 13 is a diagram showing idle subchannels that can be used for other purposes, according to some embodiments.

As shown in the diagram, the AP and STA may exchange frames (A-PPDU 1300 and response 1310) for performing channel sounding for a SST 1320, similar to what is shown in FIG. 11 and described above with reference thereto. However, as highlighted in the diagram, some of the subchannels may be idle in the response 1310 and thus can be used for other purposes. Also, it may be inefficient to transmit an ACK frame in individual subchannels. As will be described herein, a block ACK scheme can be used to more efficiently acknowledge data frames received in multiple subchannels. With the block ACK scheme, the STA may transmit a block ACK frame that includes ACK information for multiple subchannels, which avoids the need to transmit individual ACK frames and/or NACK frames in each subchannel. This may free up some of the subchannels so that they can be used for other purposes such as for transmitting data frames. Thus, with the block ACK scheme, data frames can be transmitted simultaneously with the block ACK frame in different subchannels to improve channel utilization, throughput, and latency (e.g., the STA may transmit low latency data in the data frames).

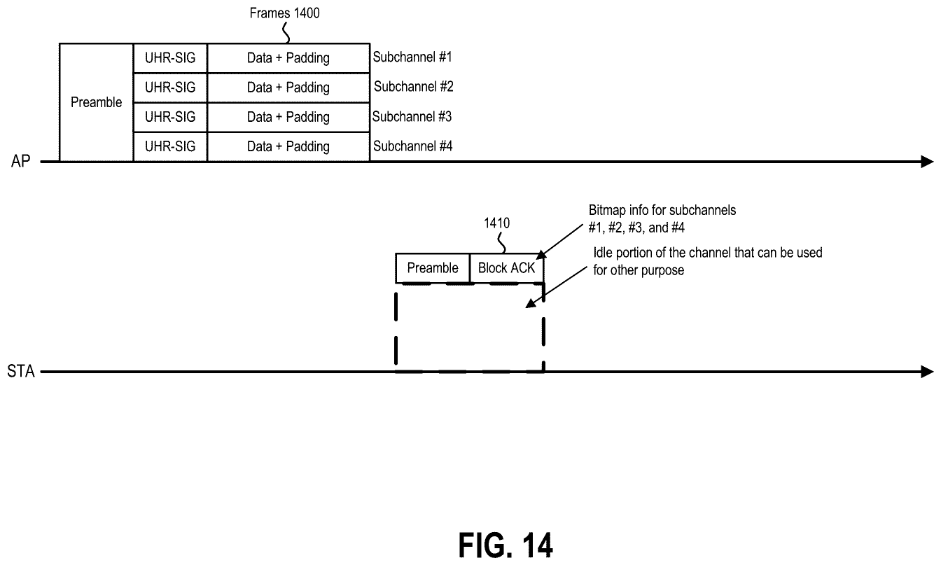

FIG. 14 is a diagram showing a block ACK acknowledgement scheme for acknowledging data frames received in multiple subchannels, according to some embodiments.

As shown in the diagram, the AP may transmit multiple data frames 1400 in multiple subchannels (subchannels #1-4) as part of an A-PPDU transmission. Each data frame may occupy a different subchannel. In response to receiving data frames 1400, the STA may transmit a block ACK frame 1410 in subchannel #1 that includes ACK information for subchannels #1-4. For example, the block ACK frame 1410 may include bitmap information indicating the subchannels in which the STA was able to successfully decode a data frame and/or the subchannels in which the STA was unable to successfully decode a data frame. For example, the bitmap information may include one bit per subchannel, where a bit being set to 1 indicates an acknowledgement (ACK) for the corresponding subchannel and a bit being set to 0 indicates no acknowledgement (NACK) for the corresponding subchannel. In an embodiment, encoding and/or hash table methods can be used for encoding the bitmap information. For example, a hash table method is useful in large networks, where the one-hot encoding result of multiple cases (a group of bits where each bit represents one of the multiple cases and only one of the bits is set to ‘1’ and the remaining bits are set to ‘0’) is converted into a hash and expressed as a compressed bitmap. Since the block ACK frame 1410 includes ACK information for multiple subchannels, there is no need to transmit individual ACK frames (or NACK frames) in additional subchannels (e.g., subchannels #2-4) as feedback. As shown in the diagram, this creates an idle portion of the channel that can be used for other purposes such as for transmitting additional data frames (e.g., data frames that include low latency data).

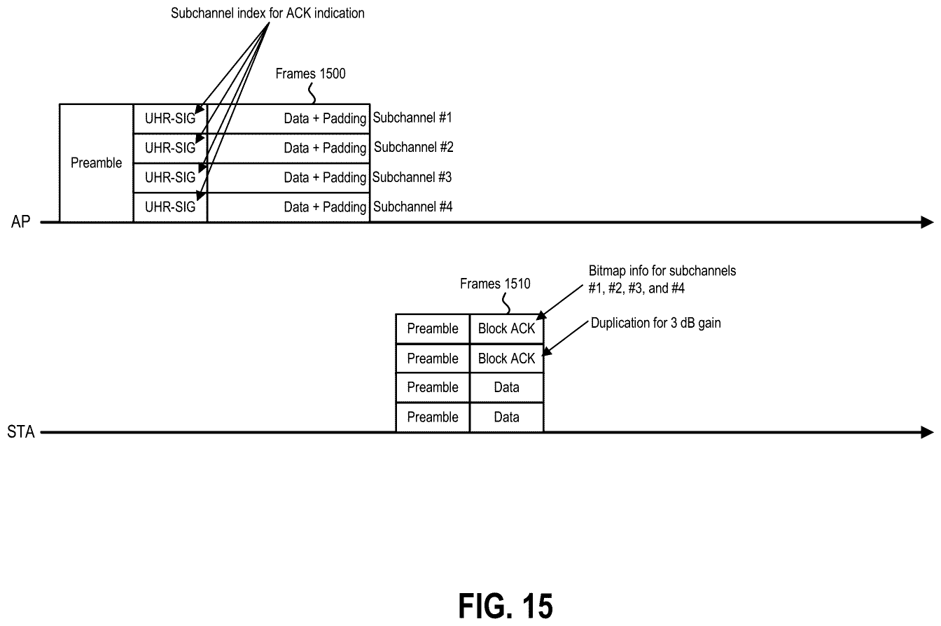

FIG. 15 is a diagram showing a block ACK frame and data frames being transmitted simultaneously, according to some embodiments.

As shown in the diagram, the AP may transmit multiple data frames 1500 in multiple subchannels (subchannels #1-4) as part of an A-PPDU transmission. Each data frame may occupy a different subchannel. In response to receiving data frames 1500, the STA may transmit a block ACK frame 1410 in subchannel #1 that includes ACK information for subchannels #1-4 (e.g., encoded as bitmap information, as described above). The STA may also transmit a duplicated block ACK frame in subchannel #2. The block ACK frame and the duplicated block ACK frame may be transmitted simultaneously (but in different subchannels). The duplicated block ACK frame may be a duplicate of the block ACK frame transmitted in subchannel #1. Duplicating the block ACK frame may effectively increase the gain of the block ACK frame at the recipient (e.g., 3 dB gain at the AP). The STA may also transmit data frames in subchannels #3 and #4. These data frames may be transmitted simultaneously with the block ACK frame and the duplicated block ACK frame. By transmitting a block ACK frame that includes ACK information for multiple subchannels, other subchannels can be freed up to be used for other purposes (besides transmitting ACK frame or NACK frame) such as for transmitting the duplicated block ACK frame (in subchannel #2 in this example) and the data frames (in subchannels #3 and #4 in this example), which allows the channel resources to be more efficiently utilized. Although not shown in the diagram, the AP may perform a SST based on the ACK information included in the block ACK frame (and the duplicated block ACK frame). For example, the AP may transmit data in the subchannels for which the ACK information indicates that a data frame was successfully received and decoded by the STA (and avoid transmitting data in the subchannels for which the ACK information indicates that a data frame was not successfully received and decoded by the STA).

In an embodiment, the UHR-SIG fields of an A-PPDU include subchannel indices for ACK indication. For example, each UHR-SIG field transmitted in a subchannel may include a subchannel index of the subchannel in which the UHR-SIG field is being transmitted (e.g., the subchannel index of subchannel #1 may be 1, the subchannel index of subchannel #2 may be 2, and so on, although it should be appreciated that other numbering/indexing schemes can be used). In an embodiment, the subchannel index for ACK indication is included in the MAC header (e.g., in reserved bits and/or an extension field of the MAC header) instead of in the UHR-SIG field. The ACK information included in the block ACK frame may use the subchannel indices for ACK indication to identify subchannels in which a data frame was successfully received and decoded (without error) and/or subchannels in which a data frame was not successfully received and decoded. For example, the block ACK frame may include bitmap information that uses the subchannel indices to identify the subchannels in which a data frame was successfully received and decoded.

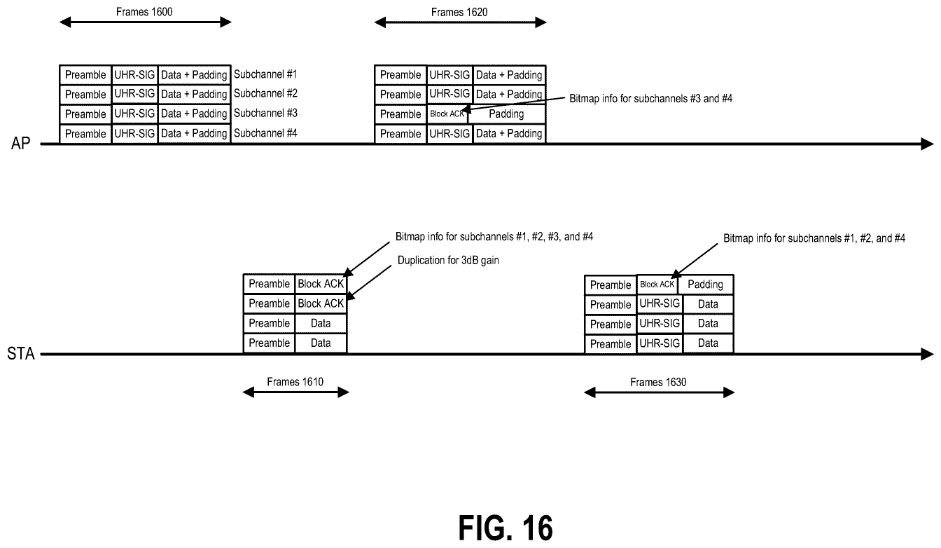

FIG. 16 is a diagram showing a frame exchange sequence using a block ACK scheme, according to some embodiments.

As shown in the diagram, the AP may transmit multiple frames 1600 in subchannels #1-4 as part of an A-PPDU transmission. Frames 1600 may include four data and padding frames that are each transmitted in different subchannels.

In response to receiving frames 1600, the STA may transmit frames 1610. Frames 1610 may include a block ACK frame transmitted in subchannel #1 that includes ACK information for subchannels #1-4, a duplicated block ACK frame (which is a duplicate of the block ACK frame transmitted in subchannel #1) transmitted in subchannel #2, and data frames transmitted in subchannels #3 and #4. The ACK information for subchannels #1-4 may indicate the subchannels in which a data and padding frame was successfully received and decoded. The ACK information may be encoded as bitmap information in the block ACK frame (and the duplicated block ACK frame), as described above.

In response to receiving frames 1610, the AP may transmit frames 1620. Frames 1620 may include a block ACK frame transmitted in subchannel #3 that includes ACK information for subchannels #3 and #4 and data and padding frames transmitted in subchannels #1, #2, and #4. In general, the block ACK frame may be transmitted in the first subchannel in terms of subchannel index in which a data frame was received (e.g., block ACK frame of frames 1620 is transmitted in subchannel #3 because that is the first subchannel (in terms of subchannel index) in which a data frame was received in frames 1610). The ACK information for subchannels #3 and #4 may be encoded as bitmap information in the block ACK frame. Padding may be added after the block ACK frame to align the end of the frame with the end of the data and padding frames. Thus, in frames 1620, the block ACK frame and the data and padding frames may be transmitted simultaneously in different subchannels. As used herein, when frames are referred to as being transmitted simultaneously, it means that the PPDUs or sub-PPDUs that carry the frames are transmitted at least partially concurrently. Thus, in frames 1620, the block ACK frame may be considered as being transmitted simultaneously with the data and padding frames because the sub-PPDU that carries the block ACK frame and the sub-PPDUs that carry the data and padding frames overlap, even though the block ACK frame portion itself is not necessarily transmitted at the same time as the data and padding frame portions.

In response to receiving frames 1620, the STA may transmit frames 1630. Frames 1630 may include a block ACK frame transmitted in subchannel #1 that includes ACK information for subchannels #1, #2, and #4 and data frames transmitted in subchannels #2-4. Padding may be added after the block ACK frame to align the end of the frame with the end of the data frames. Thus, in frames 1630, the block ACK frame and the data frames may be transmitted simultaneously in different subchannels. In this example, the data frames of frames 1630 do not need padding.

In the diagram, the data frames of frames 1610 are shown as being transmitted in legacy format and the data frames of frames 1600, 1620, and 1630 are shown as being transmitted in UHR format (e.g., there is a UHR-SIG field). It should be appreciated that the data frames can be transmitted in the same format or different formats.

An AP/STA may be able to identify the boundary between the end of data and the beginning of padding bits using information included in the MAC header or by detecting a predefined delimiter at the beginning of the padding bits.

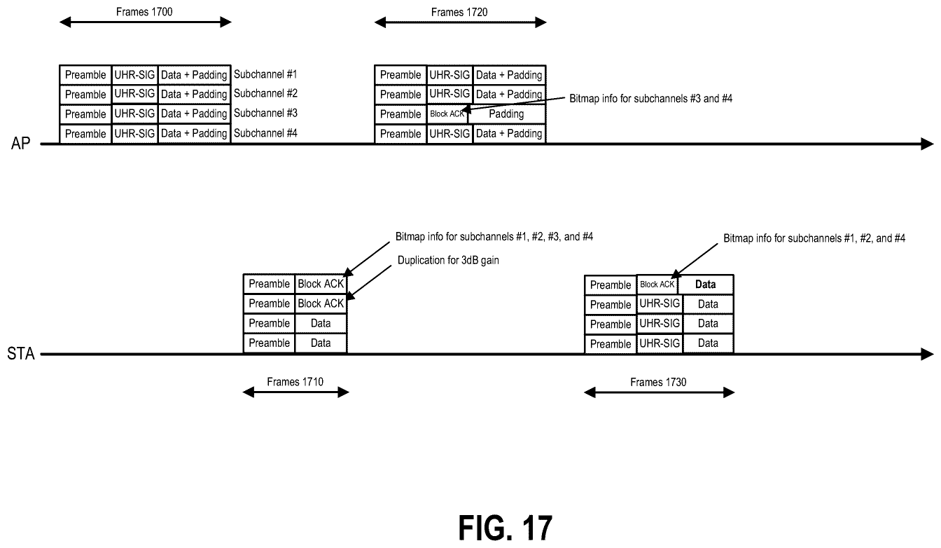

FIG. 17 is a diagram showing a frame exchange sequence using a block ACK scheme where a data frame is transmitted instead of padding bits, according to some embodiments.

As shown in the diagram, the AP and the STA may exchange frames 1700, 1710, 1720, and 1730 in a similar manner to what is shown in FIG. 16 and described above with reference thereto. However, in frames 1730, the STA transmits a data frame after transmitting the block ACK frame instead of transmitting padding bits. This may have the effect of further improving channel utilization and throughput. Even in this case, the length and rate of the legacy signal field are set to protect the entire frame extended by data bits to spoof legacy devices.

An AP/STA may be able to identify the boundary between the end of data and the beginning of padding bits using information included in the MAC header or by detecting a predefined delimiter at the beginning of the padding bits.

With the block ACK scheme disclosed herein, data frames received in multiple subchannels (e.g., received as part of an A-PPDU transmission) can be acknowledged using a block ACK frame that includes ACK information for the multiple subchannels, instead of having to transmit a separate ACK frame in each subchannel. This may free up some of the subchannels to be used for other purposes such as for data frame transmissions, which improves the channel utilization efficiency, throughput, and/or latency.

While embodiments are primarily described in a context of an 80 MHz channel that is divided into four 20 MHz subchannels, it should be appreciated that the channel and/or the subchannels may have different bandwidth sizes. Also, embodiments are primarily described in a context of communications between an AP and a STA. It should be appreciated, however, that the block ACK scheme can be implemented for communications between two STAs or between two APs. Also, it should be appreciated that the roles of the AP and STA can be reversed (e.g., the STA (instead of the AP) may be the one that initially transmits the data frames as part of an A-PPDU transmission). Also, embodiments are primarily described in a context of single-user transmissions. However, it should be appreciated that the block ACK scheme can be implemented for a multi-user scenario. Thus, the embodiments described herein should be regarded as illustrative rather than limiting.

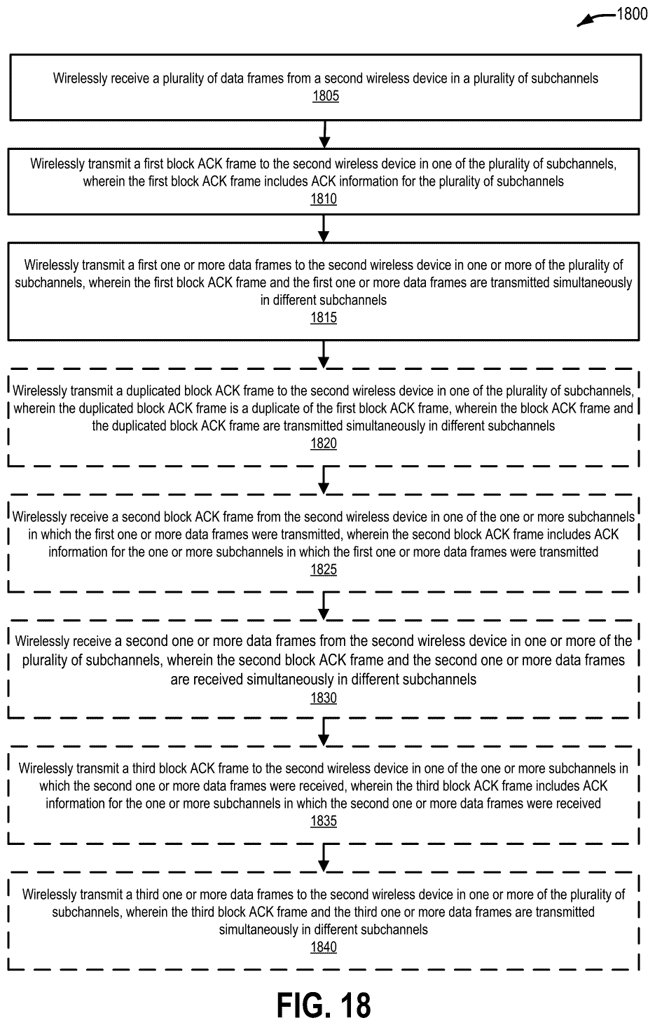

Turning now to FIG. 18, a method 1800 will be described for implementing a block ACK scheme, in accordance with an example embodiment. The method 1800 may be performed by a first wireless device in a wireless network (e.g., the STA in FIGS. 16 and 17). The first wireless device may have components similar to wireless device 104.

Additionally, although shown in a particular order, in some embodiments the operations of the method 1800 (and the other methods shown in the other figures) may be performed in a different order. For example, although the operations of the method 1800 are shown in a sequential order, some of the operations may be performed in partially or entirely overlapping time periods.

At operation 1805, the first wireless device wirelessly receives a plurality of data frames from a second wireless device in a plurality of subchannels. In an embodiment, the plurality of data frames is received in an A-PPDU that includes a plurality of sub-PPDUs each occupying one of the plurality of subchannels (e.g., with each sub-PPDU carrying one of the plurality of data frames). In an embodiment, each of the plurality of sub-PPDUs includes a signal field that includes a subchannel index of the subchannel that the sub-PPDU occupies.

At operation 1810, the first wireless device wirelessly transmits a first block ACK frame to the second wireless device in one of the plurality of subchannels, wherein the first block ACK frame includes ACK information for the plurality of subchannels. In an embodiment, the ACK information for the plurality of subchannels is encoded as bitmap information in the first block ACK frame (and the bitmap information may use the subchannel indices to identify the subchannels in which a data frame was successfully received and decoded).

At operation 1815, the first wireless device wirelessly transmits a first one or more data frames to the second wireless device in one or more of the plurality of subchannels, wherein the first block ACK frame and the first one or more data frames are transmitted simultaneously in different subchannels.

In an embodiment, at operation 1820, the first wireless device wirelessly transmits a duplicated block ACK frame to the second wireless device in one of the plurality of subchannels, wherein the duplicated block ACK frame is a duplicate of the first block ACK frame, wherein the block ACK frame and the duplicated block ACK frame are transmitted simultaneously in different subchannels.

In an embodiment, at operation 1825, the first wireless device wirelessly receives a second block ACK frame from the second wireless device in one of the one or more subchannels in which the first one or more data frames were transmitted, wherein the second block ACK frame includes ACK information for the one or more subchannels in which the first one or more data frames were transmitted.

In an embodiment, at operation 1830, the first wireless device wirelessly receives a second one or more data frames from the second wireless device in one or more of the plurality of subchannels, wherein the second block ACK frame and the second one or more data frames are received simultaneously in different subchannels.

In an embodiment, at operation 1835, the first wireless device wirelessly transmits a third block ACK frame to the second wireless device in one of the one or more subchannels in which the second one or more data frames were received, wherein the third block ACK frame includes ACK information for the one or more subchannels in which the second one or more data frames were received.

In an embodiment, at operation 1840, the first wireless device wirelessly transmits a third one or more data frames to the second wireless device in one or more of the plurality of subchannels, wherein the third block ACK frame and the third one or more data frames are transmitted simultaneously in different subchannels. In an embodiment, the first wireless device wirelessly transmits padding bits in the subchannel in which the third block ACK frame is transmitted (e.g., to align the end of the frame with the end of the third one or more data frames). In an embodiment, the first wireless device wirelessly transmits a data frame in the subchannel in which the third block ACK frame is transmitted (e.g., immediately after transmitting the third block ACK frame), wherein the data frame and the third one or more data frames are transmitted simultaneously.

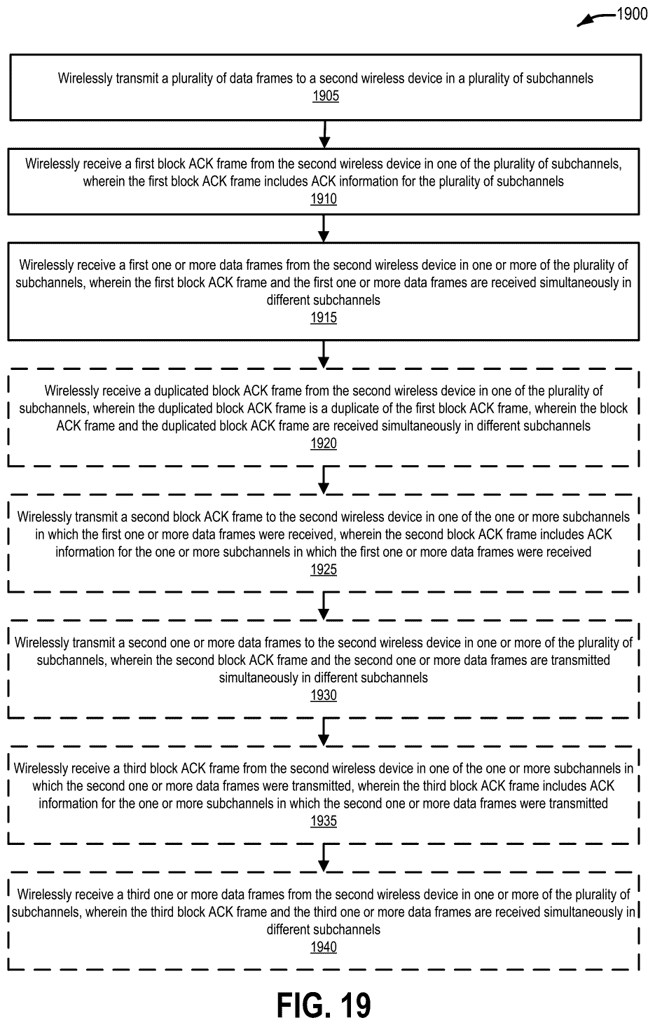

Turning now to FIG. 19, a method 1900 will be described for implementing a block ACK scheme, in accordance with an example embodiment. The method 1900 may be performed by a first wireless device in a wireless network (e.g., the AP in FIGS. 16 and 17). The first wireless device may have components similar to wireless device 104.

At operation 1905, the first wireless device wirelessly transmits a plurality of data frames to a second wireless device in a plurality of subchannels. In an embodiment, the plurality of data frames is transmitted in an A-PPDU that includes a plurality of sub-PPDUs each occupying one of the plurality of subchannels (e.g., with each sub-PPDU carrying one of the plurality of data frames). In an embodiment, each of the plurality of sub-PPDUs includes a signal field that includes a subchannel index of the subchannel that the sub-PPDU occupies.

At operation 1910, the first wireless device wirelessly receives a first block ACK frame from the second wireless device in one of the plurality of subchannels, wherein the first block ACK frame includes ACK information for the plurality of subchannels. In an embodiment, the ACK information for the plurality of subchannels is encoded as bitmap information in the first block ACK frame (and the bitmap information may use the subchannel indices to identify the subchannels in which a data frame was successfully received and decoded).

At operation 1915, the first wireless device wirelessly receives a first one or more data frames from the second wireless device in one or more of the plurality of subchannels, wherein the first block ACK frame and the first one or more data frames are received simultaneously in different subchannels.

In an embodiment, at operation 1920, the first wireless device wirelessly receives a duplicated block ACK frame from the second wireless device in one of the plurality of subchannels, wherein the duplicated block ACK frame is a duplicate of the first block ACK frame, wherein the block ACK frame and the duplicated block ACK frame are received simultaneously in different subchannels.

In an embodiment, at operation 1925, the first wireless device wirelessly transmits a second block ACK frame to the second wireless device in one of the one or more subchannels in which the first one or more data frames were received, wherein the second block ACK frame includes ACK information for the one or more subchannels in which the first one or more data frames were received.

In an embodiment, at operation 1930, the first wireless device wirelessly transmits a second one or more data frames to the second wireless device in one or more of the plurality of subchannels, wherein the second block ACK frame and the second one or more data frames are transmitted simultaneously in different subchannels.

In an embodiment, at operation 1935, the first wireless device wirelessly receives a third block ACK frame from the second wireless device in one of the one or more subchannels in which the second one or more data frames were transmitted, wherein the third block ACK frame includes ACK information for the one or more subchannels in which the second one or more data frames were transmitted.

In an embodiment, at operation 1940, the first wireless device wirelessly receives a third one or more data frames from the second wireless device in one or more of the plurality of subchannels, wherein the third block ACK frame and the third one or more data frames are received simultaneously in different subchannels.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a first wireless device in a wireless network to implement a block acknowledgement (ACK) scheme, the method comprising:
wirelessly receiving a plurality of data frames from a second wireless device in a plurality of subchannels;
wirelessly transmitting a first block ACK frame to the second wireless device in one of the plurality of subchannels, wherein the first block ACK frame includes ACK information for the plurality of subchannels; and
wirelessly transmitting a first one or more data frames to the second wireless device in one or more of the plurality of subchannels, wherein the first block ACK frame and the first one or more data frames are transmitted simultaneously in different subchannels.

2. The method of claim 1, further comprising:
wirelessly transmitting a duplicated block ACK frame to the second wireless device in one of the plurality of subchannels, wherein the duplicated block ACK frame is a duplicate of the first block ACK frame, wherein the block ACK frame and the duplicated block ACK frame are transmitted simultaneously in different subchannels.

3. The method of claim 1, further comprising:
wirelessly receiving a second block ACK frame from the second wireless device in one of the one or more subchannels in which the first one or more data frames were transmitted, wherein the second block ACK frame includes ACK information for the one or more subchannels in which the first one or more data frames were transmitted; and
wirelessly receiving a second one or more data frames from the second wireless device in one or more of the plurality of subchannels, wherein the second block ACK frame and the second one or more data frames are received simultaneously in different subchannels.

4. The method of claim 3, further comprising:
wirelessly transmitting a third block ACK frame to the second wireless device in one of the one or more subchannels in which the second one or more data frames were received, wherein the third block ACK frame includes ACK information for the one or more subchannels in which the second one or more data frames were received; and
wirelessly transmitting a third one or more data frames to the second wireless device in one or more of the plurality of subchannels, wherein the third block ACK frame and the third one or more data frames are transmitted simultaneously in different subchannels.

5. The method of claim of claim 4, further comprising:
wirelessly transmitting padding bits in the subchannel in which the third block ACK frame is transmitted.

6. The method of claim 4, further comprising:
wirelessly transmitting a data frame in the subchannel in which the third block ACK frame is transmitted, wherein the data frame and the third one or more data frames are transmitted simultaneously.

7. The method of claim 1, wherein the plurality of data frames is received in an aggregated physical layer protocol data unit (A-PPDU) that includes a plurality of sub-PPDUs each occupying one of the plurality of subchannels.

8. The method of claim 7, wherein each of the plurality of sub-PPDUs includes a signal field that includes a subchannel index of the subchannel that the sub-PPDU occupies.

9. The method of claim 8, wherein the ACK information for the plurality of subchannels is encoded as bitmap information in the first block ACK frame.

10. A method performed by a first wireless device in a wireless network to implement a block acknowledgement (ACK) scheme, the method comprising:
wirelessly transmitting a plurality of data frames to a second wireless device in a plurality of subchannels;
wirelessly receiving a first block ACK frame from the second wireless device in one of the plurality of subchannels, wherein the first block ACK frame includes ACK information for the plurality of subchannels; and
wirelessly receiving a first one or more data frames from the second wireless device in one or more of the plurality of subchannels, wherein the first block ACK frame and the first one or more data frames are received simultaneously in different subchannels.

11. The method of claim 10, further comprising:
wirelessly receiving a duplicated block ACK frame from the second wireless device in one of the plurality of subchannels, wherein the duplicated block ACK frame is a duplicate of the first block ACK frame, wherein the block ACK frame and the duplicated block ACK frame are received simultaneously in different subchannels.

12. The method of claim 10, further comprising:
wirelessly transmitting a second block ACK frame to the second wireless device in one of the one or more subchannels in which the first one or more data frames were received, wherein the second block ACK frame includes ACK information for the one or more subchannels in which the first one or more data frames were received; and
wirelessly transmitting a second one or more data frames to the second wireless device in one or more of the plurality of subchannels, wherein the second block ACK frame and the second one or more data frames are transmitted simultaneously in different subchannels.

13. The method of claim 12, further comprising:
wirelessly receiving a third block ACK frame from the second wireless device in one of the one or more subchannels in which the second one or more data frames were transmitted, wherein the third block ACK frame includes ACK information for the one or more subchannels in which the second one or more data frames were transmitted; and
wirelessly receiving a third one or more data frames from the second wireless device in one or more of the plurality of subchannels, wherein the third block ACK frame and the third one or more data frames are received simultaneously in different subchannels.

14. The method of claim 10, wherein the plurality of data frames is transmitted in an aggregated physical layer protocol data unit (A-PPDU) that includes a plurality of sub-PPDUs each occupying one of the plurality of subchannels.

15. A first wireless device to implement a block acknowledgement (ACK) scheme in a wireless network, the first wireless device comprising:
a radio frequency transceiver;
a memory device storing a set of instructions; and
a processor coupled to the memory device, wherein the set of instructions when executed by the processor causes the first wireless device to:
wirelessly receive a plurality of data frames from a second wireless device in a plurality of subchannels;
wirelessly transmit a first block ACK frame to the second wireless device in one of the plurality of subchannels, wherein the first block ACK frame includes ACK information for the plurality of subchannels; and
wirelessly transmit a first one or more data frames to the second wireless device in one or more of the plurality of subchannels, wherein the first block ACK frame and the first one or more data frames are transmitted simultaneously in different subchannels.

16. The first wireless device of claim 15, wherein the set of instructions when executed by the processor further causes the first wireless device to:
wirelessly transmit a duplicated block ACK frame to the second wireless device in one of the plurality of subchannels, wherein the duplicated block ACK frame is a duplicate of the first block ACK frame, wherein the block ACK frame and the duplicated block ACK frame are transmitted simultaneously in different subchannels.

17. The first wireless device of claim 15, wherein the set of instructions when executed by the processor further causes the first wireless device to:
wirelessly receive a second block ACK frame from the second wireless device in one of the one or more subchannels in which the first one or more data frames were transmitted, wherein the second block ACK frame includes ACK information for the one or more subchannels in which the first one or more data frames were transmitted; and
wirelessly receive a second one or more data frames from the second wireless device in one or more of the plurality of subchannels, wherein the second block ACK frame and the second one or more data frames are received simultaneously in different subchannels.

18. The first wireless device of claim 17, wherein the set of instructions when executed by the processor further causes the first wireless device to:
wirelessly transmit a third block ACK frame to the second wireless device in one of the one or more subchannels in which the second one or more data frames were received, wherein the third block ACK frame includes ACK information for the one or more subchannels in which the second one or more data frames were received; and
wirelessly transmit a third one or more data frames to the second wireless device in one or more of the plurality of subchannels, wherein the third block ACK frame and the third one or more data frames are transmitted simultaneously in different subchannels.

19. The first wireless device of claim 15, wherein the plurality of data frames is received in an aggregated physical layer protocol data unit (A-PPDU) that includes a plurality of sub-PPDUs each occupying one of the plurality of subchannels.

20. The first wireless device of claim 19, wherein each of the plurality of sub-PPDUs includes a signal field that includes a subchannel index of the subchannel that the sub-PPDU occupies, wherein the ACK information for the plurality of subchannels is encoded as bitmap information in the first block ACK frame.
